(19) United States
(12) Patent Application Publication
(10) Pub. No.: US 2006/0080265 A1
(43) Pub. Date: Apr. 13, 2006

(54) Method for pricing products in a retail store

(76) Inventors: Mark Hinds, Cincinnati, OH (US); Michael Wilhite, Cincinnati, OH (US)

Correspondence Address: TAFT, STETTINIUS & HOLLISTER LLP, SUITE 1800, 425 WALNUT STREET, CINCINNATI, OH, 45202-3957, US

(21) Appl. No.: 11/073,354

(22) Filed: Mar. 4, 2005

Related U.S. Application Data
(60) Provisional application No. 60/618,300, filed on Oct. 13, 2004.

(51) Int. Cl. G06F 17/00

(52) U.S. Cl. 705/400

(57) ABSTRACT

A method for pricing products such as goods that are sold in a retail store. The method of the present invention is carried out using the following five-step process: (a) evaluating transaction data for a plurality of consumers; (b) classifying the plurality of consumers into a plurality of consumer groups; (c) identifying a product category; (d) classifying products in the product category into a plurality of product groups, the product groups being based at least in part on the plurality of consumer groups; and (e) setting the retail price of a product in the product category, the retail price being based at least in part on the product group into which the product is classified.

### CROSS-REFERENCE TO RELATED APPLICATIONS

This application claims the priority of U.S. Provisional Patent Application Ser. No. 60/618,300, filed Oct. 13, 2004, and entitled “METHOD FOR PRICING PRODUCTS IN A RETAIL STORE”, the disclosure of which is incorporated herein by reference.

### BACKGROUND

Pricing of products is one of the most important tasks faced by companies in the retail sector. While the goal of maximizing sales revenue is simple enough, the price that achieves that goal is often difficult to determine. The price of a particular product will be largely constrained by market conditions, yet it remains a formidable task to ascertain the actual market conditions and evaluate them in a way that yields the optimum price. For example, if the price of a product is set below the price that consumers would be willing to pay, each sale will yield less revenue than it could otherwise yield, thus reducing total sales revenue. If the price of a product is set too high, a substantial number of consumers will no longer buy the product, thus decreasing sales volume. Somewhere below this too-high price is the optimum price, which maintains sufficient sales volume so as to maximize total sales revenue.

The market conditions relevant to product pricing include information about consumer demand for the product and information about substitutes for the product. There is a need for a method that enables a retailer to determine these parameters using readily available data in order to approximate the optimum price for a particular product.

### SUMMARY

The present invention provides a method for pricing products which, according to an exemplary embodiment, can be goods that are sold in a retail store. Generally, the method of the present invention can be carried out using the following five-step process:
(a) evaluating transaction data for a plurality of consumers;
(b) classifying the plurality of consumers into a plurality of consumer groups from the transaction data;
(c) identifying a product category;
(d) classifying products in the product category into a plurality of product groups, where the product group classifications are determined, at least in part, based upon the distribution of the consumer groups transacting for the products in the product category; and
(e) setting the retail price of a product in the product category, where the retail price is based at least in part on the product group into which the product is classified.

In an exemplary embodiment, the transaction data includes “shopping purchase data,” which can be information regarding consumers' shopping history, including the identity of products and quantities thereof that the consumers have purchased. In a detailed embodiment, the shopping purchase data is collected using frequent shopper cards (also known as loyalty cards or reward cards).

The consumer groups are established based upon the concept that consumers may base their respective transaction decisions upon different factors such as demographic factors (age, income, or geographic location) and/or other personality factors (price sensitivity or negotiation tendencies, for example). Thus, in a more detailed embodiment, the plurality of consumer groups may indicate different degrees of price sensitivity. In an even more detailed embodiment, the consumers in each of the plurality of consumer groups have a similar degree of price sensitivity. In an even more detailed embodiment, each of the plurality of consumers is assigned to one of the plurality of consumer groups based on the consumer's degree of price sensitivity. In an even more detailed embodiment, each consumer's degree of price sensitivity is determined from the products that the consumer has purchased, the product groups of the products that the consumer has purchased, and/or from the degree of price sensitivity of other consumers who have purchased the same products as the first consumer. In an even more detailed embodiment, the consumer group into which a first consumer is classified is determined from the consumer group into which other consumers who have purchased the same or similar products as the first consumer are classified, or from the product groups of the products that the consumer has purchased.

In an alternate detailed embodiment, the product category comprises products having common physical properties. Alternatively, the product category can comprise products that may be used for a common purpose, products having positive cross-elasticities of demand, or products having a common classification under the North American Industry Classification System or Standard Industrial Classification system.

In an alternate detailed embodiment, each product in the product category is classified into one of the plurality of product groups. In an even more detailed embodiment, the product group into which a product is classified is determined from the identity of consumers who have purchased that product, the price sensitivity of consumers who have purchased that product, the distribution of consumer groups who have purchased the product, or the consumer group into which a sufficient fraction of the consumers who purchased the product are classified. In an alternate more detailed embodiment, the product group into which a first product is classified is determined from other products purchased by consumers who have purchased the first product, or from the product group into which other products, which have been purchased by a sufficient fraction of the consumers who purchased the first product, are classified. In an alternate more detailed embodiment, a product group comprises products that have been purchased by consumers, a sufficient fraction of whom are classified in a common consumer group.

In an alternate detailed embodiment, the price of a first product, which is classified in a first product group whose products are purchased by consumers having a lower price sensitivity, will be higher than the price of a second product, which is classified in a second product group whose products are purchased by consumers having a higher price sensitivity. In a more specific embodiment, products in the second product group will be more competitively priced (versus the retail establishment's local competitors, for example), and products in the first product group may be priced with a lower emphasis on competition.

Again, while exemplary embodiments discussed herein classify consumers into consumer groups based upon relative price sensitivity of the consumers and, in turn, classify products into product groups based upon the distribution of the price sensitivity-based consumer groups that have purchased the products, it is within the scope of the invention to classify consumers into consumer groups based upon any demographic or personality-based factor (or any combination thereof) that may have an effect on the consumer's decisions with respect to a transaction.

### BRIEF DESCRIPTION OF THE DRAWINGS

FIG. 1 is a flow chart diagram of a method according to an exemplary embodiment of the present invention.

FIG. 2 shows an exemplary embodiment of the step of classifying a plurality of consumers into a plurality of consumer groups.

FIGS. 3 through 6 are graphs depicting selection criteria for four exemplary consumer groups.

FIG. 7 is a chart depicting selection criteria for four exemplary consumer groups.

FIGS. 8 through 11 are graphs depicting selection criteria for four exemplary product groups.

### DETAILED DESCRIPTION

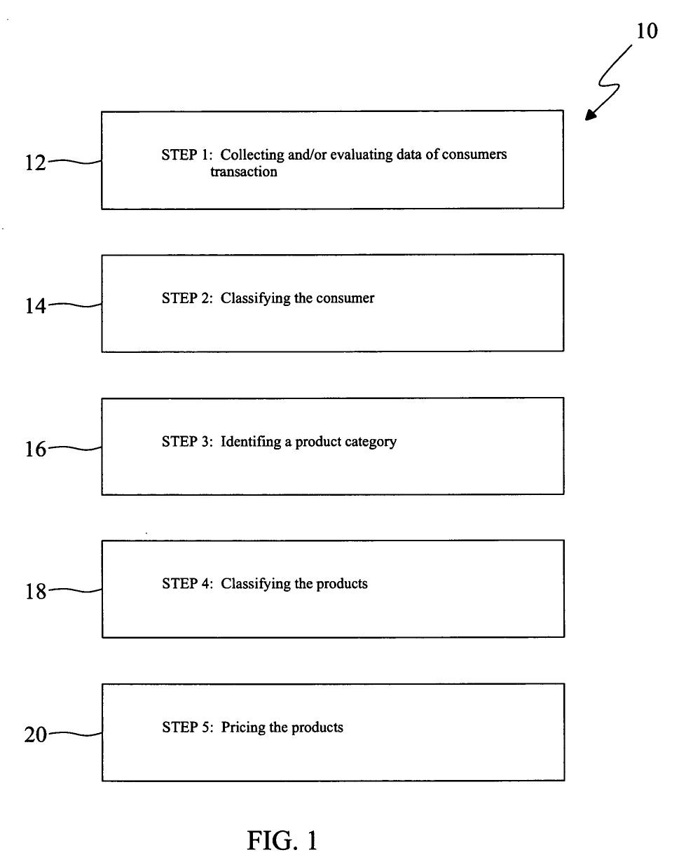

FIG. 1 shows a flow chart diagram of an exemplary method 10 of the present invention. The method 10 begins with the first step 12, evaluating transaction data for a plurality of consumers. “Transaction data” refers to data relating to any transaction or interaction between a consumer and a business. In an exemplary embodiment, transaction data includes “shopping purchase data,” which can be information regarding a consumer's shopping history, including the identity of products and quantities thereof that the consumer has purchased. As used herein, the term “products” includes not only consumer products that can be purchased in a retail store, but also any other product, service, or thing of value that can be furnished by a business to a consumer. This step 12 can include the act of collecting the shopping purchase data, or it can evaluate previously-collected data. The shopping purchase data can be collected using a unique identification tag or card, commonly known as a “frequent shopper car” or “loyalty card,” carried by each consumer. Such cards or tags contain a unique identification code stored by a bar code, magnetic media, or other data storage device and can be read by an electronic device in various manners that are well known to persons skilled in the art.

When a consumer goes through the checkout process at a store and the products being purchased are scanned, the unique identification code of the consumer's frequent shopper card can also be read by electronic device. The store's computer system can then compile a record of the products being purchased during this particular sale and associate that list with the unique identification code of the consumer. By repeating this process each time the consumer visits the store and makes purchases, the store can build a cumulative record of a particular consumer's shopping history, including the identity of products and quantities thereof that the consumer has purchased. The compiled record of a consumer's shopping history can be stored in a database and analyzed to develop a profile regarding the consumer's product preferences, as discussed in the next step. The “consumer” whose shopping history is profiled can be an individual person or a household, for example, consisting of a group of persons residing at the same address or using the same credit card account, or even a business or governmental entity.

In an alternative embodiment, a consumer's shopping purchase data can be associated with the consumer using other consumer identification information (such as a telephone number, store credit card, bank credit card, or checking account number) instead of codes from frequent shopper cards. In this manner, the details of a particular transaction can be matched to the consumer's previous transactions, thus facilitating the continuing addition of transactional information to each consumer's record in the database.

Each consumer's record in the database can comprise a plurality of transaction entries or records, one for each transaction by that consumer. For each of these transaction records, there is provided, in the exemplary embodiment: a code identifying the SKU/product(s) purchased by the customer for the transaction; a code identifying the particular transaction or ‘basket’; a code identifying the customer or household for the which the transaction is attributed; a code identifying the store in which the transaction occurred; data concerning the quantity of products purchased and the amount spent; data concerning the date, time, etc. of the purchase; and any other data or codes, such as a code indicating a geographical region for the purchase, as could be useful to generate reports based upon such transactional data.

The code in the transaction record identifying the SKU/product can be used to retrieve details pertaining to that product from a separate database containing a plurality of “product records,” one for each product. For each “product record” in the product database, there is provided, in the exemplary embodiment: product grouping or categorization data or codes; product UPC data; manufacturer or supplier data or codes; and any other data or codes, such as suggested retail price data, as could be useful to generate reports based upon a combination of transaction data and product data.

The code in the transaction record identifying the customer or household for the transaction can be used to retrieve details pertaining to that household from a separate database containing a plurality of “household records,” one for each household. For each “household record,” there may be provided, in the exemplary embodiment: data and/or codes pertaining to the customer's demographics, shopping history, shopping preferences, and any other data or codes as could be useful to generate reports based upon a combination of transaction data and customer/household data.

The code in the transaction record identifying the store in which the transaction occurred can be used to retrieve details pertaining to that store from a separate database containing a plurality of “store records,” one for each store. For each “store record,” there is provided, in the exemplary embodiment: store name data; store location data or codes; and any other data or codes as could be useful to generate reports based upon a combination of transaction data and store data.

As will be appreciated by those of ordinary skill, the above-described database record structures are only exemplary in nature and that unlimited combinations of database records and hierarchies are available to cross-reference transaction information, product information, customer/household information, store information, location information, timing information, and any other appropriate information with one another. Additionally, one of ordinary skill will appreciate that the invention is not limited for use with retail store transactions and that the invention can be used with most (if not all) types of transactions (such as financial/banking transactions, insurance transactions, service transactions, etc.), where the database structures and hierarchies will be adapted for generating reports on such alternate transaction data.

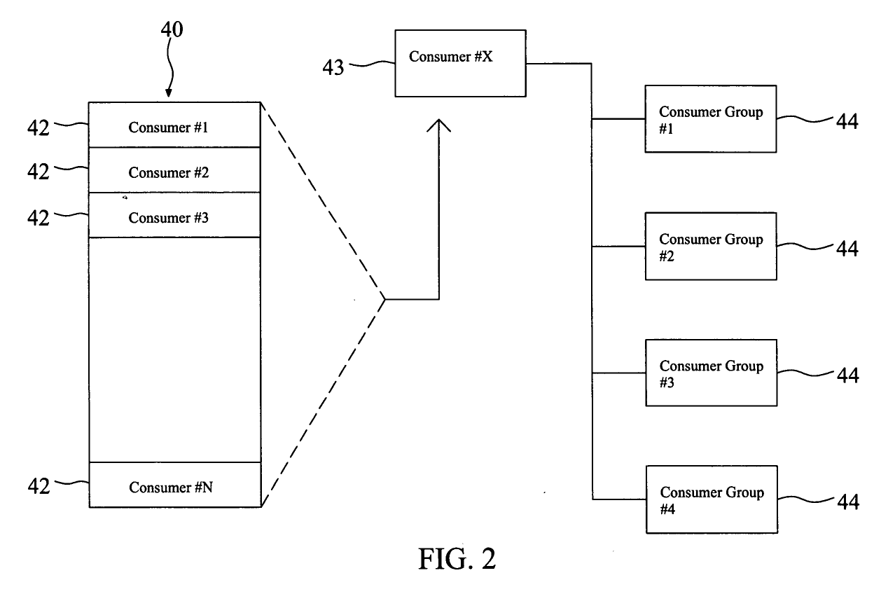

In the second step 14 of the method 10, the consumers are classified into a plurality of consumer groups. As shown diagrammatically in FIG. 2, the database 40 contains a plurality of consumer records 42, one for each consumer for whom shopping purchase data has been compiled. Each consumer in the database 40 can be classified into one of the consumer groups 44. In the exemplary embodiment, the consumer group into which a particular consumer is placed will be determined from characteristics about that consumer that can be ascertained from the consumer's shopping history. Because a consumer's shopping history, including the identity of products and quantities thereof that the consumer has purchased, provides valuable insight into the consumer's lifestyle, financial means, and other important characteristics, it allows consumers to be divided into groups according to various selection criteria. The consumer group into which a particular consumer is placed may also be based upon demographic data and/or personality data, which may or may not be ascertained from the consumer's transaction history. Demographic data may include, but is certainly not limited to, age data, income data, geographic data, and education-level data. Personality data (also referred to as the consumer's “transaction personality”) may include, but is certainly not limited to, price sensitivity, negotiation tendencies, coupon usage, attention to promotions, loyalty, attention to product locations or configurations, and the like. Those of ordinary skill in the art will appreciate the numerous sources for such demographic and/or personality data.

In the exemplary embodiment shown in FIG. 2, there are four consumer groups 44 into which consumers may be placed. These exemplary consumer groups classify consumers according to their price sensitivity. Price sensitivity is a desirable way in which to classify consumers because it is a strong indicator of which particular products the consumer is likely to purchase. For example, most product categories (e.g., pet food, ice cream, canned goods, wine, etc.) contain several product offerings by multiple manufacturers, and the several product offerings usually differ in price. Within a given product category, the consumer usually can choose between low-end products that are relatively inexpensive, high-end products that have higher prices, and other products having prices somewhere in between the low-end and the high-end for that product category. Because very price sensitive consumers will tend to purchase less expensive products and high-end consumers will tend to purchase more expensive products, we can ascertain a particular consumer's price sensitivity by analyzing the products that the consumer buys. Each consumer can be classified into the appropriate consumer group depending on the price sensitivity indicated by list of products in the consumer's shopping history.

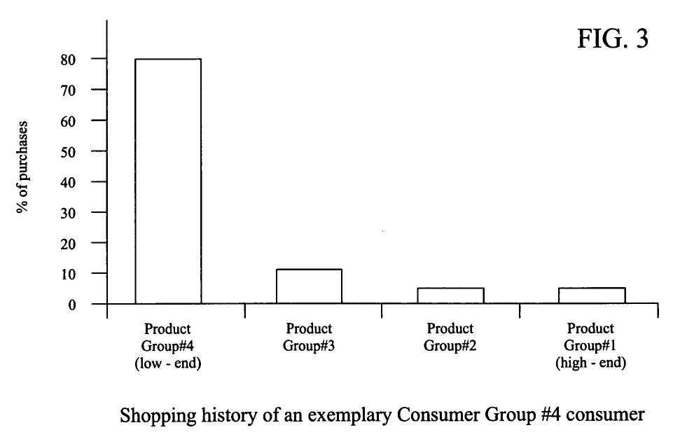

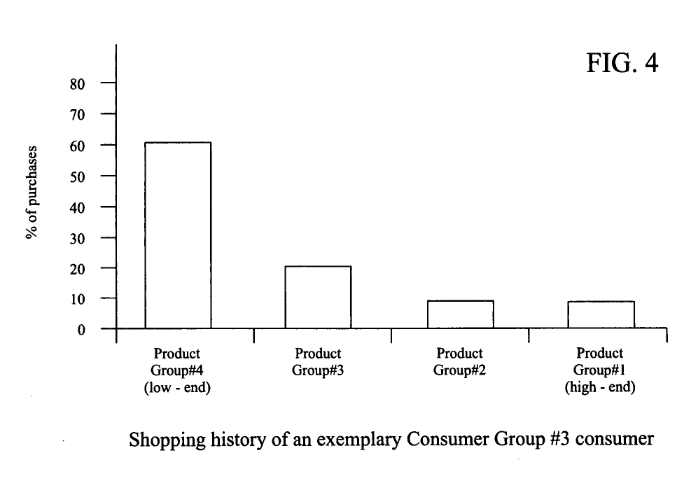

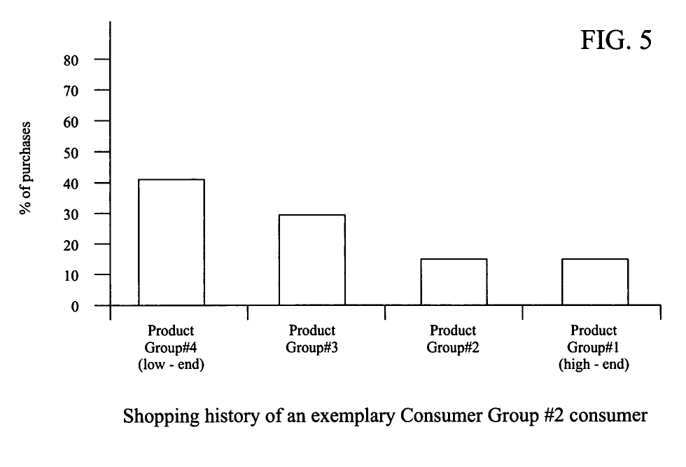

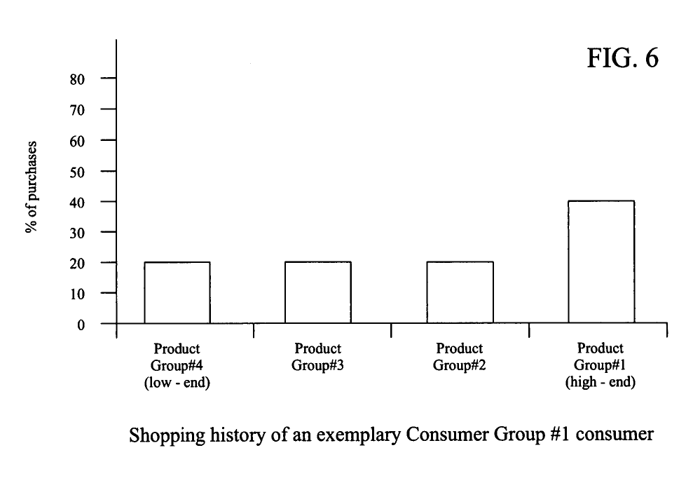

The consumer group into which a particular consumer is classified can be determined by analyzing the product group classification of the products in the consumer's shopping history. For example, referring again to the four consumer groups of FIG. 2, a consumer who purchases primarily low-end products can be classified in Consumer Group #4. Specific numerical thresholds can be set for making these determinations. For example, a consumer whose purchases consist of at least 80% low-end products can be classified in Consumer Group #4 (as shown in FIG. 3). Similarly, a consumer whose purchases consist of at least 40% high-end products can be classified in Consumer Group #1 (as shown in FIG. 4) (the different percentages in these examples are logically appropriate because affluent consumers tend to buy low-end products more often than price sensitive consumers buy high-end products.) As an additional example, a consumer whose purchases consist of between 50% and 80% low-end products can be classified in Consumer Group #3 (as shown in FIG. 4), and a consumer whose purchases consist of between 30% and 50% low-end products and less than 20% high-end products can be classified in Consumer Group #2 (as shown in FIG. 4). The specific cutoff percentages and selection criteria for each consumer group can vary depending on the ranges observed for each product group's share of consumers' purchases, as well as the distribution of the consumers along this range. These factors, among others, can be used in the analysis that determines the qualifications for classification into each of the consumer groups.

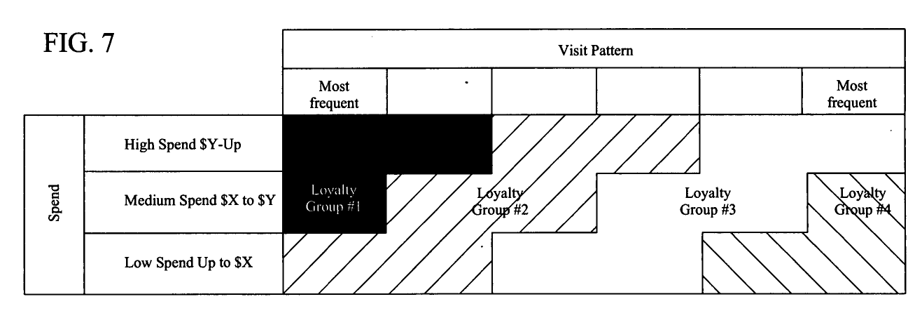

In an alternate embodiment, consumers can be classified into consumer groups based on their perceived “loyalty” to the store or to a particular product. A consumer who spends more money at a store or shops more frequently will be perceived as more loyal by the store. Similarly, a consumer who spends more money on a particular product or buys the product more frequently will be perceived as a more loyal buyer of that product. FIG. 7 is a chart illustrating how consumers may be classified into consumer groups based on their perceived loyalty to a store. In this example, there are four consumer groups: Loyalty Group 1 through 4. Each consumer is placed into one of these consumer groups based on how much the consumer spends at the store and how often the consumer shops at the store, as indicated by the chart.

In an alternate embodiment, consumers can be classified into consumer groups based on their response to promotions or other incentives. A consumer's shopping history can include data indicating whether each product in the shopping history was the subject of a promotion at the time it was purchased, and this information can then be analyzed to determine how strongly each consumer responds to promotions. The analysis can also determine and what types of promotions (e.g., coupons, rebates, volume discounts) and what promoted products each consumer responds to.

As discussed above, it is certainly within the scope of the invention to classify consumers into consumer groups based upon demographic and/or personality factors or upon multiple combinations of such.

Once the database of consumers has been classified into consumer groups, as described above, the remainder of the exemplary method (steps three through five) is concerned with pricing products. The first step in this endeavor (the third step 16 in the overall method 10) is identification of a product category. Generally speaking, a product category defines a line of competing products that are functionally interchangeable. In other words, if two products are used for the same purpose by the consumer, then they can be said to belong to the same product category. Examples of product categories are pet food, ice cream, canned goods, and wine.

One of the most useful ways to define product category is by the economists' notion of cross-elasticity of demand. The cross-elasticity of demand measures how the demand for one product changes in response to a change in another product's price. If demand for product A rises when the price of product B rises, and vice versa, then product A and product B are viewed by consumers as substitutes—when the price of one product rises, some consumers will buy the other product instead, thus increasing its demand. Thus, if two products have positive cross-elasticities of demand, meaning that the demand for each rises when the price of the other rises, they are economic substitutes. It makes sense to classify such products in a common product category because they are viewed as functionally interchangeable by consumers. A good example of such products is Pennzoil® motor oil and Valvoline® motor oil; if the price of one rises, some consumers will buy the other instead because it performs the same function and is now comparatively less expensive. Two unrelated products will have cross-elasticities of demand equaling zero because they have no functional relation and thus are not substitutes for each other. A good example of such products is a Remington® 12-gauge shotgun and Land O'Lakes® butter; because these goods are completely unrelated, a rise in the price of one will have no effect on the demand for the other.

In addition to cross-elasticities of demand, other ways can be used to determine which products should be classified together in a common product category, such as the U.S. Department of Commerce's North American Industry Classification System or Standard Industrial Classification system. Nevertheless, it is within the scope of the present invention to use alternative ways of classifying products in a product category, which may include subjective or even arbitrary decisions.

Once a product category has been identified, the next step 18 of the exemplary method 10 is to classify products in the product category into a plurality of product groups. The goal of placing products into product groups is to implement a classification system that will aid in determining an appropriate price for each product. Accordingly, one of the most useful ways to group products is by the type of consumer that typically buys the product.

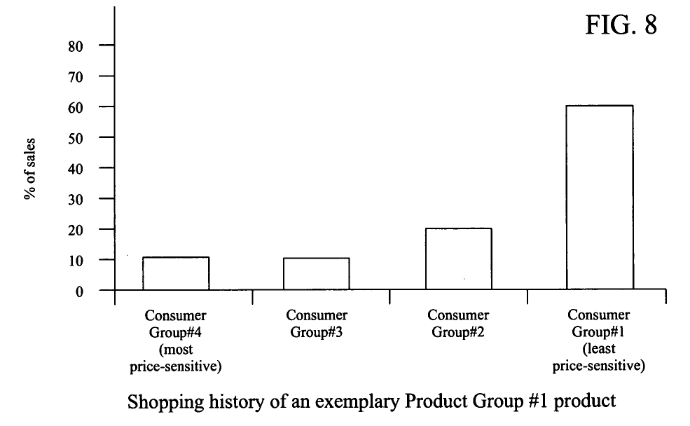

In an exemplary embodiment, there are four product groups into which products can be placed, ranging from Product Group #1 (the high-end products that are typically purchased by affluent consumers who are relatively insensitive to price) to Product Group #4 (the low-end products that are typically purchased by consumers who are sensitive to price). In order to determine the product group into which a particular product should be classified, we look to the distribution of consumer groups represented in the list of consumers who have purchased the product. This list can be compiled from the same shopping purchase data from consumers as described above. From the database that tracks what products each consumer has purchased, we can construct a list identifying the consumers who have purchased each product. Using the consumer group classification assigned to each consumer in the second step 14 of the method 10 (described above), we can determine what kind of consumer (based on degree of price sensitivity in an exemplary embodiment) tends to buy each product. Using this information, we can construct a chart similar to those depicted in FIGS. 8 through 11 for each product, showing the distribution of consumer groups purchasing the product.

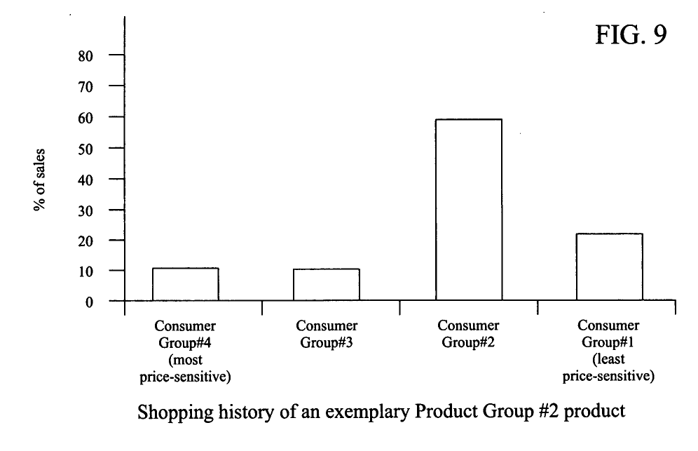

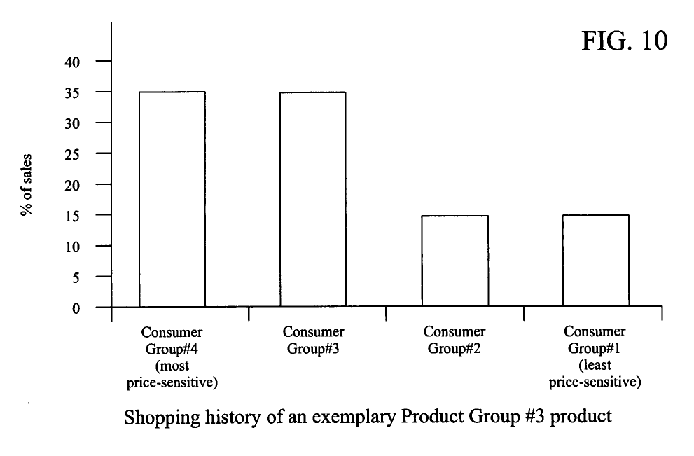

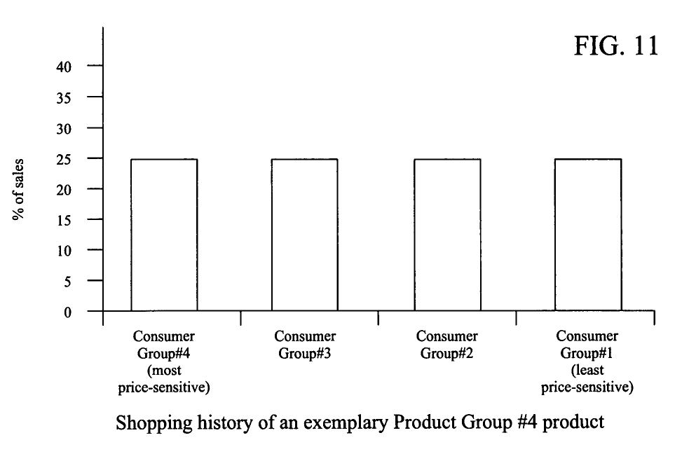

For example, if affluent or upscale (Consumer Group #1) consumers account for 60% of a product's sales, as seen in FIG. 8, that product can be classified in Product Group #1. If Consumer Group #2 consumers account for 60% of a product's sales, as seen in FIG. 9, that product can be classified in Product Group #2. If Consumer Group #3 and Consumer Group #4 consumers jointly account for over half of a product's sales, as seen in FIG. 10, that product can be classified in Product Group #3. If no particular consumer group dominates a product's sales, as seen in FIG. 11, that product can be classified in Product Group #4. For example, we could employ a selection criterion providing that, if the fraction of a product's sales to no pair of two consumer groups differs by more than 10%, then the product will be classified in Product Group #4.

Once the products have been classified into product groups, one remaining step 20 of the method 10 is to set the prices of the products in the product groups. Most product categories (e.g., pet food, ice cream, canned goods, and wine) have a range of prices, with some premium products in the category selling at the high end of the range, some lesser products in the category selling at the low end of the range, and other products in the category selling at prices near the middle of the range.

The classification of products into product groups (as performed in the fourth step 18, described above) greatly assists the pricing of the products because a product's classification indicates where along that spectrum the product should be priced. For example, if the price for a half gallon of ice cream ranges from $2.29 on the low end to $6.99 on the high end, then a particular brand of ice cream that is classified in Product Group #1 should be priced at the upper end of this range. Similarly, a particular brand of ice cream that is classified in Product Group #2 should be priced near the middle of this range. By pricing products in this manner, sellers can more closely approximate the optimum price for each product, that is, the price at which total sales revenue is maximized. A product that is purchased primarily by affluent consumers (i.e., a Product Group #1 product) can be priced higher without sacrificing sales volume. By contrast, a Product Group #3 or a Product Group #4 product, which depends on a large number of price sensitive consumers for its sales, will experience a significant reduction in sales volume if it is priced too high.

In an exemplary embodiment, the Product Group #3 products and Product Group #4 products in a product category are priced to compete directly with regional competitors because consumers who are price sensitive will be comparing prices of such products between regional competitors, while Product Group #1 products are priced to provide a strong margin because the less price sensitive consumers buying such products will typically not compare prices with the store's regional competitors.

In an alternative embodiment, a substitute for the fifth step 20 of the exemplary method 10 can include a step of determining rebates and discounts to be offered on particular products. Alternatively, the method can include the step of determining other promotional details, such as store display configuration, for particular products. In these alternative embodiments, a product's classification in a particular product group can be analyzed to determine what action, such as offering a rebate or using a more visible store display, should be taken with respect to that particular product.

Just as consumers were classified into consumer groups based upon the distribution of product groups found in each consumer's purchase history, the products were classified into product groups based upon the distribution of consumer groups that purchased each product. It may be a recursive process, with the consumer classification being determined from the product classification which, in turn, is determined from the consumer classification. As with the determination of consumer groups, the specific cutoff percentages and selection criteria for each product group can vary depending on the ranges observed for each consumer group's share of various products' sales, as well as the distribution of the products along this range. These factors, among others, can be used in the analysis that determines the qualifications for classification into each of the product groups.

The method according to the present invention can be implemented on a computer system such as a personal computer, a client/server system, a local area network, or the like. The computer system may include a display unit, a main processing unit, and one or more input/output devices. The one or more input/output devices may include a keyboard, a mouse, and a printer. The display unit may be any typical display device, such as a cathode ray tube, a liquid crystal display, or the like.

The main processing unit may further include a central processing unite (CPU), a memory, and a persistent storage device that are interconnected together. The CPU may control the operation of the computer and may execute one or more software applications that implement the steps of an embodiment of the present invention. The software applications may be stored permanently in the persistent storage device that stores the software applications even when the power is off and then loaded into the memory when the CPU is ready to execute the particular software application. The persistent storage device may be a hard disk drive, an optical drive, a tape drive or the like. The memory may include a random access memory (RAM), a read only memory (ROM), or the like.

Having described the invention with reference to exemplary embodiments, it is to be understood that the invention is defined by the claims and it not intended that any limitations or elements describing the exemplary embodiment set forth herein are to be incorporated into the meanings of the claims unless such limitations or elements are explicitly listed in the claims. Likewise, it is to be understood that it is not necessary to meet any or all of the identified advantages or objects of the invention disclosed herein in order to fall within the scope of any claims, since the invention is defined by the claims and since inherent and/or unforeseen advantages of the present invention may exist even though they may not have been explicitly discussed herein.

What is claimed is:

1. A method for establishing the retail price of a product, comprising the steps of:
evaluating shopping purchase data for a plurality of consumers;
classifying the plurality of consumers into a plurality of consumer group based, at least in part, upon the evaluation of shopping purchase data;
identifying a product category;
classifying products in the product category into a plurality of product groups based, at least in part, upon a distribution consumer groups purchasing the products in the product category; and
setting the retail price of a product in the product category based, at least in part, upon the product group into which the product is classified.

2. The method of claim 1, wherein the shopping purchase data includes the identification of products that each of the plurality of consumers has purchased.

3. The method of claim 2, wherein the shopping purchase data is collected using frequent shopper cards.

4. The method of claim 1, wherein each of the plurality of consumers is classified into one of the plurality of consumer groups.

5. The method of claim 4, wherein the plurality of consumer groups indicate different degrees of price sensitivity.

6. The method of claim 5, wherein each consumer's degree of price sensitivity is determined, at least in part, from the identity of products that the consumer has purchased.

7. The method of claim 5, wherein each consumer's degree of price sensitivity is determined, at least in part, from the product groups of the products that the consumer has purchased.

8. The method of claim 5, wherein a first consumer's degree of price sensitivity is determined from degree of price sensitivity of other consumers who have purchased the same products as the first consumer.

9. The method of claim 4, wherein the consumer group into which a first consumer is classified is determined, at least in part, from the consumer group into which other consumers, who have purchased the same products as the first consumer, are classified.

10. The method of claim 4, wherein the consumer group into which a consumer is classified is determined, at least in part, from the product groups of the products that the consumer has purchased.

11. The method of claim 1, wherein the product category comprises products having common physical properties.

12. The method of claim 1, wherein the product category comprises products that may be used for a common purpose.

13. The method of claim 1, wherein the product category comprises products having positive cross-elasticities of demand.

14. The method of claim 1, wherein the product category comprises products having a common classification under the North American Industry Classification System.

15. The method of claim 1, wherein the product category comprises products having a common classification under the Standard Industrial Classification system.

16. The method of claim 1, wherein the product group into which a product is classified is determined from the consumer group into which a predetermined fraction of the consumers who purchased the product are classified.

17. The method of claim 1, wherein the product group into which a first product is classified is determined from the product group into which other products, which have been purchased by a predetermined fraction of the consumers who purchased the first product, are classified.

18. The method of claim 1, wherein a product group comprises products that have been purchased by consumers, a sufficient fraction of whom are classified in a common consumer group.

19. The method of claim 1, wherein the step of setting a retail price for a product includes the step of setting the price of a first product, which is classified in a first product group whose products are purchased by consumers having a lower price sensitivity, relatively higher than the price of a second product, which is classified in a second product group whose products are purchased by consumers having a higher price sensitivity.

20. The method of claim 1, wherein the step of setting the retail price for a product includes the step of setting the price of a product, which is classified in a product group purchased more often by consumers having a higher price sensitivity, to be directly competitive with a retail store's local competition.

21. A method for establishing the retail price of a product, comprising the steps of:
evaluating transaction data for a plurality of consumers;
classifying the plurality of consumers into a plurality of consumer groups based, at least in part, upon the evaluation of transaction data;
identifying a product category;
classifying a product from the product category into one of a plurality of product groups based, at least in part, upon a distribution of consumer groups transacting for the product; and
setting the retail price of the product in the product category based, at least in part, upon the product group into which the product is classified.

22. The method of claim 21, wherein each of the plurality of consumers is classified into one of the plurality of consumer groups.

23. The method of claim 22, wherein the plurality of consumer groups indicate different degrees of price sensitivity.

24. The method of claim 21, wherein the product category comprises products having positive cross-elasticities of demand.

25. The method of claim 21, wherein the product category includes a plurality of products; and
wherein each product in the product category is classified into one of the plurality of product groups.

26. The method of claim 21, wherein a product group comprises products that have been purchased by consumers, a predetermined fraction of whom are classified in a common consumer group.

27. The method of claim 21, wherein the step of setting a retail price for a product includes the step of setting the price of a first product, which is classified in a first product group whose products are purchased by consumers having a lower price sensitivity, relatively higher than the price of a second product, which is classified in a second product group whose products are purchased by consumers having a higher price sensitivity.

28. The method of claim 21, wherein the step of setting the retail price for a product includes the step of setting the price of a product, which is classified in a product group purchased more often by consumers having a higher price sensitivity, to be directly competitive with a retail store's local competition.

29. A computer system comprising software programmed to perform a method for establishing a business transaction strategy, comprising the steps of:
classifying a plurality of consumers into a plurality of consumer groups based upon at least one of consumer transaction history data and consumer demographic data;
identifying a product;
collecting product transaction history data for the product from the plurality of consumers classified into the consumer groups;
categorizing the product into a product category based upon an analysis of the product transaction history data; and
establishing a business transaction strategy for the product based upon the product category into which the product is categorized.

30. The computer system of claim 29, wherein the step of establishing a business transaction strategy for the product is based upon an analysis of a distribution of the consumer groups' purchases of the product from the product transaction history data.

31. The computer system of claim 29, wherein the step of classifying a plurality of consumers into a plurality of consumer groups includes the steps of, for each consumer:
determining from the consumer transaction history a transaction personality; and
classifying the consumer into one of the plurality of consumer groups based, at least in part, upon the consumer's transaction personality.

32. The computer system of claim 31, wherein the step of establishing a business transaction strategy for the product is based upon an analysis of a distribution of the consumer groups' purchases of the product from the vehicle transaction history data.

33. The computer system of claim 31, wherein the transaction personality is based upon one or more tendencies taken from a group consisting of:
a consumer's price-sensitivity;
a consumer's brand loyalty;
a consumer's product loyalty;
a consumer's attention to promotions;
a consumer's use of coupons;
a consumer's attention to product layout;
a consumer's payment method; and
a consumer's tendency to negotiate.

34. The computer system of claim 33, wherein the step of classifying the consumer into one of the plurality of consumer groups is based upon a combination of the consumer's transaction personality and the consumer's demographic data.

35. The computer system of claim 29, wherein the step of establishing a business transaction strategy for the product includes one or more steps taken from a group consisting of the steps of:
setting a price for the product;
establishing a product promotion for the product;
modifying a product promotion for the product;
modifying a product position for the product within a retail establishment;
modifying a product display for the product within a retail establishment;
modifying a coupon strategy for the product;
setting a price for another product having a predetermined relationship with the product;
establishing a product promotion for another product having a predetermined relationship with the product;
modifying a product promotion for another product having a predetermined relationship with the product;
modifying a product position for another product having a predetermined relationship with the product within a retail establishment;
modifying a product display for another product having a predetermined relationship with the product within a retail establishment; and
modifying a coupon strategy for another product having a predetermined relationship with the product.

36. The computer system of claim 35, wherein the step of classifying a plurality of consumers into a plurality of consumer groups includes the steps of, for each consumer:
determining from the consumer transaction history a transaction personality; and
classifying the consumer into one of the plurality of consumer groups based, at least in part, upon the consumer's transaction personality.

37. The computer system of claim 36, wherein the transaction personality is based upon one or more tendencies taken from a group consisting of:
a consumer's price-sensitivity;
a consumer's brand loyalty;
a consumer's product loyalty;
a consumer's attention to promotions;
a consumer's use of coupons;
a consumer's attention to product layout;
a consumer's payment method; and
a consumer's tendency to negotiate.

38. The computer system of claim 29, wherein the method further comprises the step of identifying a product category, wherein the categorizing and establishing steps are performed for a plurality of products in the product category.

39. The computer system of claim 29, wherein the consumer transaction history data and the product transaction history data are taken from one or more databases of transaction history data.

40. The computer system of claim 39, wherein the one or more databases of transaction history data include data collected from the use of frequent shopper cards.

41. The computer system of claim 39, wherein the one or more databases of transaction history data include data collected from the use of credit cards.

42. The computer system of claim 29, wherein the step of classifying a plurality of consumers into a plurality of consumer groups includes the steps of, for each consumer:
determining from the consumer transaction history a price sensitivity; and
classifying the consumer into one of the plurality of consumer groups based, at least in part, upon the consumer's price sensitivity, wherein each of the consumer groups respectively correspond to different predetermined levels of consumer price sensitivity.

43. The computer system of claim 42, wherein the step of establishing a business transaction strategy for the product includes the steps of setting a price for the product.

44. The computer system of claim 43, wherein the step of categorizing the product into a product category is based upon an analysis of a distribution of the consumer groups' purchases of the product from the product transaction history data, wherein each of the product categories respectively correspond to different predetermined levels of importance as to whether products falling within the product categories should be competitively priced or not.

45. A computer system comprising software programmed to perform a method for establishing a business transaction strategy, comprising the steps of:
classifying a plurality of consumers into a plurality of consumer groups based upon at least one of consumer transaction history data and consumer demographic data;
identifying a transaction vehicle;
collecting vehicle transaction history data for the transaction vehicle from the plurality of consumers classified into the consumer groups;
analyzing of the vehicle transaction history data; and
establishing a business transaction strategy for the transaction vehicle based upon the analysis of the vehicle transaction history data.

46. The computer system of claim 45, wherein the step of establishing a business transaction strategy for the transaction vehicle is based upon an analysis of a distribution of the consumer groups utilization of the transaction vehicle from the vehicle transaction history data.

47. The computer system of claim 45, wherein the step of classifying a plurality of consumers into a plurality of consumer groups includes the steps of, for each consumer:
determining from the consumer transaction history a transaction personality; and
classifying the consumer into one of the plurality of consumer groups based, at least in part, upon the consumer's transaction personality.

48. The computer system of claim 47, wherein the step of establishing a business transaction strategy for the transaction vehicle is based upon an analysis of a distribution of the consumer groups utilization of the transaction vehicle from the vehicle transaction history data.

49. The computer system of claim 47, wherein the transaction personality is based upon one or more tendencies taken from a group consisting of:
a consumer's price-sensitivity;
a consumer's brand loyalty;
a consumer's product loyalty;
a consumer's attention to promotions;
a consumer's use of coupons;
a consumer's attention to product layout;
a consumer's payment method; and
a consumer's tendency to negotiate.

50. The computer system of claim 47, wherein the step of classifying the consumer into one of the plurality of consumer groups is based upon a combination of the consumer's transaction personality and the consumer's demographic data.

51. The computer system of claim 45, wherein the transaction vehicle includes a first product, and the step of establishing a business transaction strategy for the transaction vehicle includes one or more steps taken from a group consisting of the steps of:
setting a price for the first product;
establishing a product promotion for the first product;
modifying a product promotion for the first product;
modifying a product position for the first product within a retail establishment;
modifying a product display for the first product within a retail establishment;
modifying a coupon strategy for the first product;
setting a price for a second product having a predetermined relationship with the first product;
establishing a product promotion for a second product having a predetermined relationship with the first product;
modifying a product promotion for a second product having a predetermined relationship with the first product;
modifying a product position for a second product having a predetermined relationship with the first product within a retail establishment;
modifying a product display for a second product having a predetermined relationship with the first product within a retail establishment; and
modifying a coupon strategy for a second product having a predetermined relationship with the first product.

52. The computer system of claim 51, wherein the step of classifying a plurality of consumers into a plurality of consumer groups includes the steps of, for each consumer:
determining from the consumer transaction history a transaction personality; and
classifying the consumer into one of the plurality of consumer groups based, at least in part, upon the consumer's transaction personality.

53. The computer system of claim 52, wherein the transaction personality is based upon one or more tendencies taken from a group consisting of:
a consumer's price-sensitivity;
a consumer's brand loyalty;
a consumer's product loyalty;
a consumer's attention to promotions;
a consumer's use of coupons;
a consumer's attention to product layout;
a consumer's payment method; and
a consumer's tendency to negotiate.

54. The computer system of claim 45, wherein the transaction vehicle includes a promotional item.

55. The computer system of claim 54, wherein the step of establishing a business transaction strategy for the transaction vehicle includes one or more steps taken from a group consisting of:
modifying a promotional strategy associated with the promotional item;
setting a price for a product associated with the promotional item;
establishing a product promotion for a product associated with the promotional item;
modifying a product promotion for a product associated with the promotional item;
modifying a product position for a product associated with the promotional item within a retail establishment;
modifying a product display for a product associated with the promotional item within a retail establishment; and
modifying a coupon strategy for a product associated with the promotional item.
